(19) United States
(12) Patent Application Publication
(10) Pub. No.: US 2010/0235363 A1
(43) Pub. Date: Sep. 16, 2010

(54) ELECTRONIC DEVICE AND METHOD FOR DISPLAYING MULTIMEDIA FILES

(75) Inventors: SHU-YUN HUANG, Taoyuan (TW); YI-CHIA LEE, Taoyuan (TW); YI-TING HAN, Taoyuan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN COMMUNICATION TECHNOLOGY CORP., Taoyuan County (TW)

(21) Appl. No.: 12/535,780

(22) Filed: Aug. 5, 2009

(30) Foreign Application Priority Data
Mar. 13, 2009 (TW) 98108156

(51) Int. Cl. G06F 17/30

(52) U.S. Cl. 707/748; 707/E17.009

(57) ABSTRACT

A method for displaying multimedia files via an electronic device using a first display program and a second display program to classify and rank the multimedia files. The first display program classifies the multimedia files to one or more categorized groups according to a first feature of each image file, and ranks the multimedia files in each categorized group according to a second feature of each image file. The second display program classifies the multimedia files to one or more categorized groups according to the second feature of each image file, and ranks the multimedia files in each categorized group according to the first feature of each image file.

### BACKGROUND

1. Technical Field

Embodiments of the present disclosure generally relate to electronic devices, and more particularly to an electronic device and a method for displaying multimedia files.

2. Description of Related Art

Electronic devices, such as a digital camera, a computer, and a mobile phone, can be used to store multimedia files. The multimedia files may be text files, image files, audio files, or video files, for example.

Typically, the multimedia files are organized only according by dates, such as timestamps (creation dates) of image files. FIG. 1 and FIG. 2 respectively illustrates digital albums that classify the image files. The digital albums in FIG. 1 classify the image files according by months. The digital albums in FIG. 2 classify the image files according to both months and weeks. However, it is easy for one to forget the date when a certain image file was created. Thus, it is inconvenient and time consuming to locate a specific image if the digital albums are only classified by dates.

### BRIEF DESCRIPTION OF THE DRAWINGS

FIG. 1 is an existing displaying mode of multimedia files;

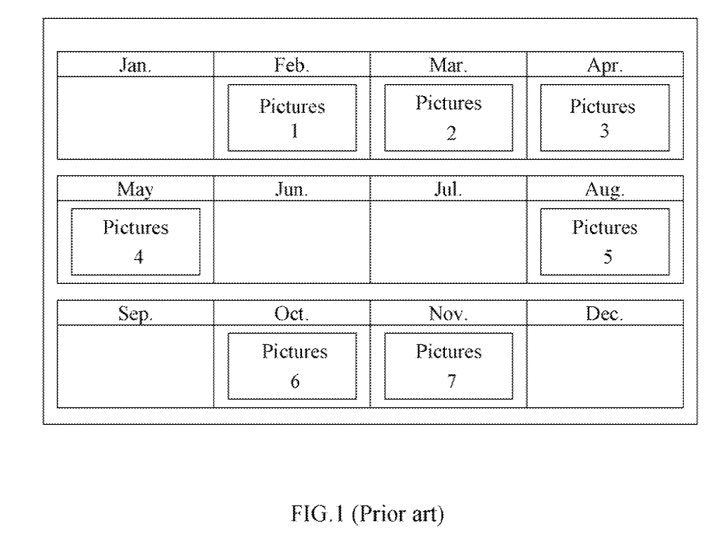

FIG. 2 is another existing displaying mode of multimedia files;

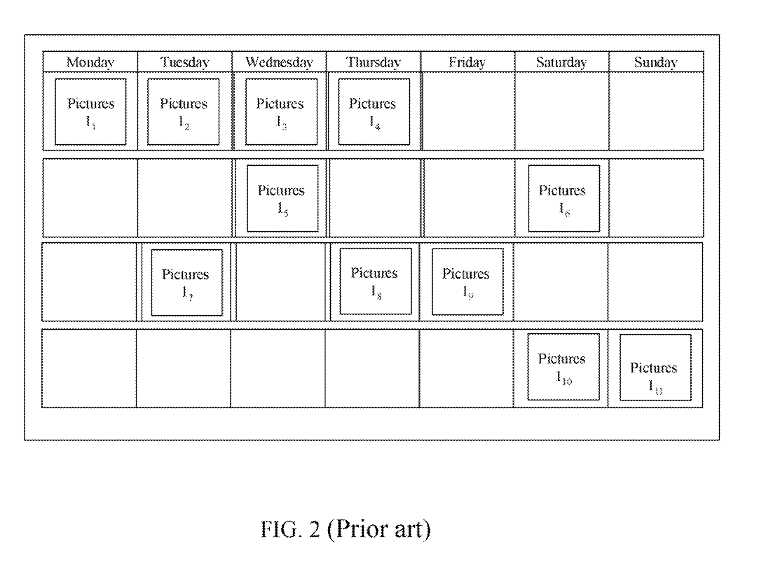

FIG. 3 is a block diagram of one embodiment of an electronic device for displaying multimedia files;

FIG. 4 is a block diagram of one embodiment illustrating a flowchart of classifying and ranking multimedia files using a first display program;

FIG. 5 is a block diagram of one embodiment of a first displaying mode of multimedia files classified and ranked using the first display program;

FIG. 6 is a block diagram of one embodiment illustrating a flowchart of classifying and ranking multimedia files using a second display program;

FIG. 7 is a block diagram of one embodiment of a first displaying mode of multimedia files classified and ranked using the second display program;

FIG. 8 is a block diagram of one embodiment of a second displaying mode of multimedia files classified and ranked using the first display program; and

FIG. 9 is a block diagram of one embodiment of the second displaying mode of multimedia files classified and ranked using the second display program.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

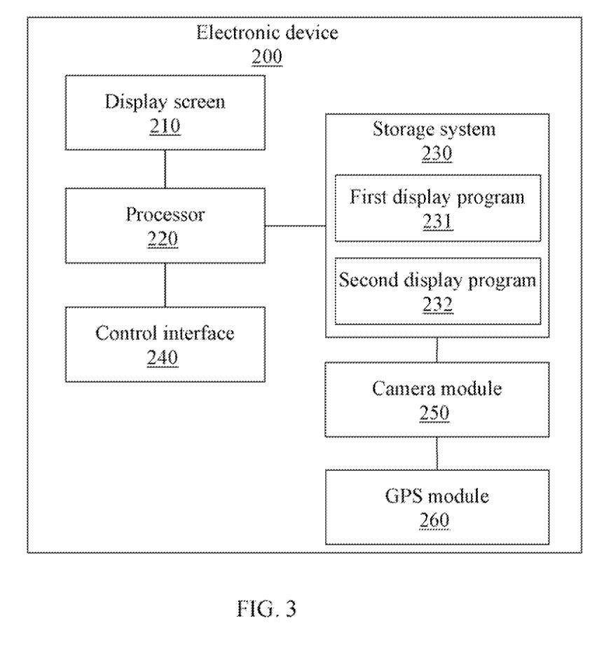

FIG. 3 is a block diagram of one embodiment of an electronic device 200. The electronic device 200 can display multimedia files. The multimedia files may be text files, image files, audio files, or video files. The following description takes the image files as an example of the multimedia files. The electronic device 200 may be a computer, a digital camera, a mobile phone, or a personal digital assistant (PDA), for example.

In one embodiment, the electronic device 200 includes a display screen 210, a processor 220, a storage system 230, a control interface 240, a camera module 250, and a global positioning system (GPS) module 260. The storage system 230 stores the image files. In one embodiment, the storage system 230 further stores a first display program 231 and a second display program 232. The first display program 231 and the second display program 232 can be used to classify and rank the image files.

The display screen 210 is used to display the image files. Depending on the embodiment, the display screen 210 may include a touch-panel for input. The touch-panel may include a capacitive touch-screen or a resistive touch-screen, depending on the embodiment.

The processor 220 is electronically connected to the storage system 230, and executes the first display program 231 and the second display program 232 to classify and rank the image files. The processor 220 also can output the classified and ranked image files via the display screen 210.

The control interface 240 is used to browse each of the image files that are stored in the storage system 230. In one embodiment, the control interface 240 may be the touch-panel included in the display screen 210. In another embodiment, the control interface 240 may be a keyboard or a mouse electronically connected to the electronic device 200 internally or externally.

The camera module 250 may be used to capture images scenes, people, and animals, for example. The captured images are stored as the image files in the storage system 230 by the processor 220. In one embodiment, the camera module 250 also records a timestamp metadata of each image file as a time parameter of the image file. The time parameter of each image file may be stored into the storage system 230 by the processor 220. In one embodiment, the time parameter may include, but not limited to, a year, a quarter, a month, or a day, for example.

The GPS module 260 records geographic metadata of each image file when the image file is captured. The geographic metadata of each image file can be regarded as a geographic parameter of the image file. In one embodiment, the GPS module 260 records the geographic metadata by determining a longitude and latitude of where the image file was captured. In one embodiment, the geographic parameter of each image file may include, but not limited to, a longitude and latitude, or a locale, for example.

The first display program 231 stored in the storage system 230 is operable to classify the image files into one or more categorized groups according to a first feature of each image file. In one embodiment, the first feature of each image file may be the time parameter of each image file. The first display program 231 is further operable to rank the image files in each categorized group according to a second feature of each image file. In one embodiment, the second feature of each image file may be the geographic parameter of each image file.

The second display program 232 stored in the storage system 230 is operable to classify the image files to one or more categorized groups according to the second feature of each image file. As mentioned above, the second feature of each image file may be the geographic parameter of each image file. The second display program 232 is further operable to rank the image files in each categorized group according to the first feature of each image file. As mentioned above, the first feature may be the time parameter of each image file.

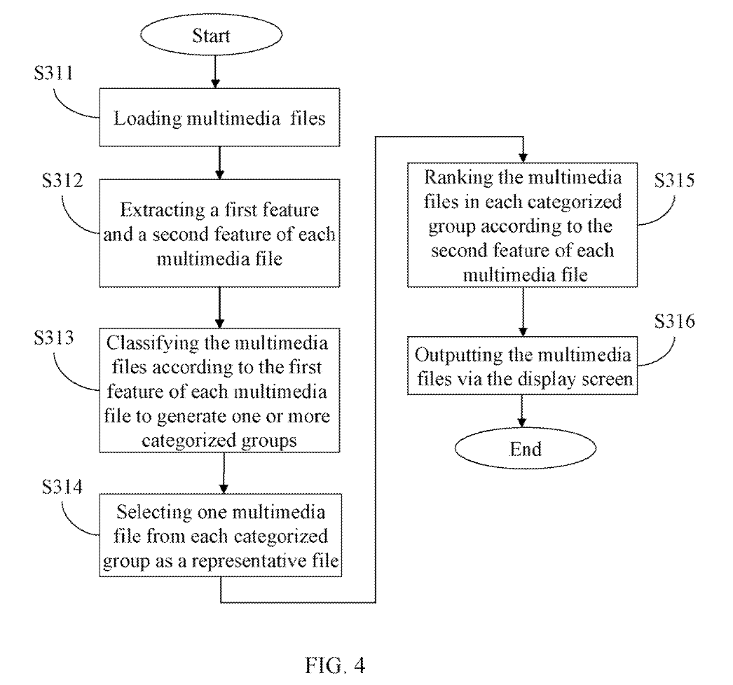

FIG. 4 is a block diagram of one embodiment illustrating a flowchart of classifying and ranking the image files using the first display program 231. Depending on the embodiment, additional blocks in the flow of FIG. 4 may be added, others removed, and the ordering of the blocks may be changed.

In block S311, the processor 220 loads image files from the storage system 230. As mentioned above, the image files may be captured by the camera module 250.

In block S312, the processor 220 extracts a first feature and a second feature of each image file from the storage system 230. As mentioned above, the first feature may be a time parameter of each image file, including a year, a quarter, a month, or a day, for example, and the second feature may be a geographic parameter of each image file, including a longitude and latitude, or a locale, for example.

In block S313, the processor 220 classifies the image files according to the first feature of each image file to generate one or more categorized groups. It may be understood that, each categorized group includes at least one image file.

In block S314, the processor 220 selects one image file from each categorized group as a representative image.

In block S315, the processor 220 ranks the image files in each categorized group according to the second feature of each image file.

In block S316, the processor 220 outputs the classified and ranked image files via the display screen 210 of the electronic device 200.

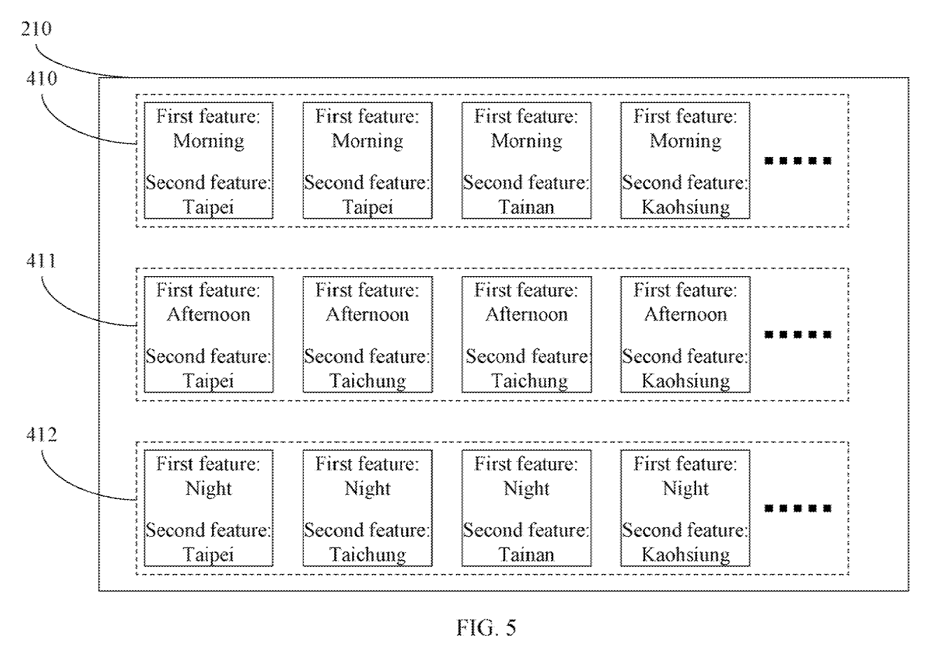

FIG. 5 is a block diagram of one embodiment of a first displaying mode of the image files classified and ranked by using the first display program 231. According to FIG. 5, the processor 220 classifies the image files according to the first feature of each image file, namely a time parameter of each image file to generate three categorized groups including a “Morning” categorized group 410, an “Afternoon” categorized group 411, and a “Night” categorized group 412. The processor 220 further ranks the image files in each categorized group 410-412 according to the second feature of each image file, namely a geographic parameter of each image file. As seen from FIG. 5, the geographic parameter of each image file includes a locale, such as Taipei, Taichung, Tainan, or Kaohsiung. The processor 220 displays all the image files according to the categorized group 410-412 and the rank via the display screen 210. Users can shift the categorized groups 410-412 by using the control interface 240, such as the mouse or directional keys “↑” and “↓” of the keyboard that is electronically connected to the electronic device 200 or by sliding of a finger on the touch-panel included in the display screen 210. Users also can shift the image files in each categorized group 410-412 by using the mouse or directional keys “←” and “→” of the keyboard or by sliding of a finger on the touch-panel.

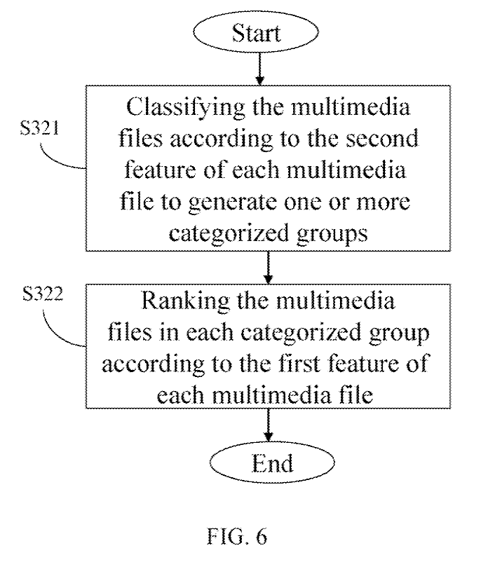

FIG. 6 is a block diagram of one embodiment illustrating a flowchart of classifying and ranking the image files using the second display program 232. Depending on the embodiment, additional blocks in the flow of FIG. 6 may be added, others removed, and the ordering of the blocks may be changed.

In block S321, the processor 220 classifies the image files according to the second feature of each image file to generate one or more categorized groups.

In block S322, the processor 220 ranks the image files in each categorized group according to the first feature of each image file.

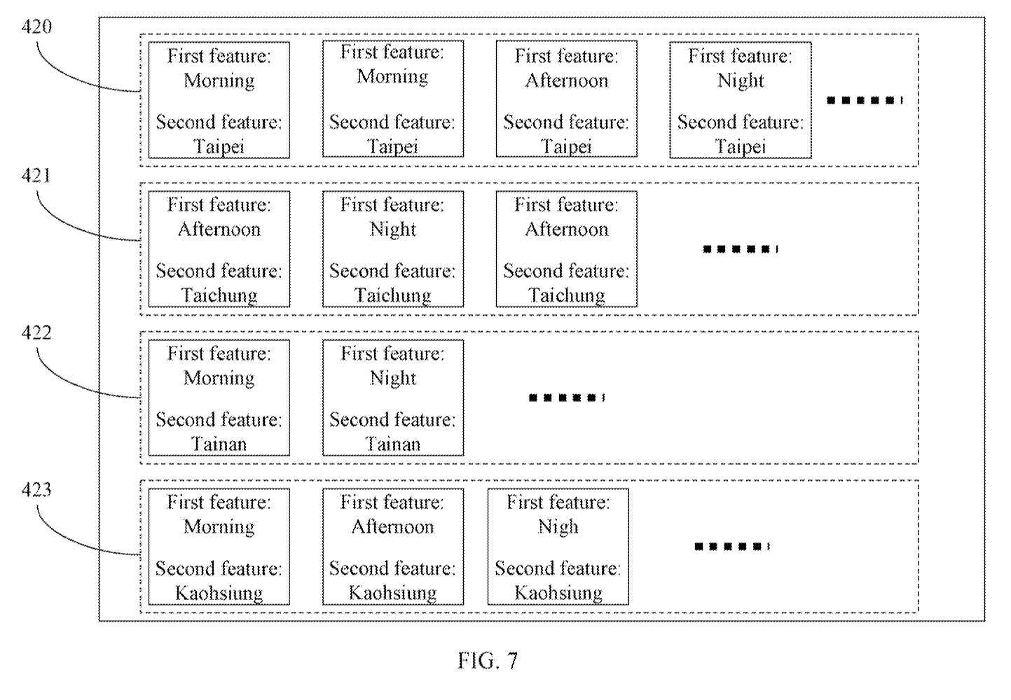

FIG. 7 is a block diagram of one embodiment of a first displaying mode of the image files classified and ranked by using the second display program 232. According to FIG. 7, the processor 220 classifies the image files according to the second feature of each image file, namely a geographic parameter of each image file to generate four categorized groups including a “Taipei” categorized group 420, a “Taichung” categorized group 421, a “Tainan” categorized group 422, and a “Kaohsiung” categorized group 423. The processor 220 further ranks the image files in each categorized group 420-423 according to the first feature of each image file, namely a time parameter of each image file. As seen from FIG. 7, the time parameter of each image file includes Morning, Afternoon, or Night. The processor 220 displays all the image files according to the categorized group 420-423 and the rank via the display screen 210.

It may be understood that, the first display program 231 and the second display program 232 can be executed according to users' need. If a user want to classify the image files according to the first feature of each image file, then the user can use the first display program 231. If a user want to classify the image files according to the second feature of each image file, then the user can use the second display program 232. A user also can classify the image files according to both the first feature of each image file and the second feature of each image file by using the first display program 231 and the second display program 232 successively.

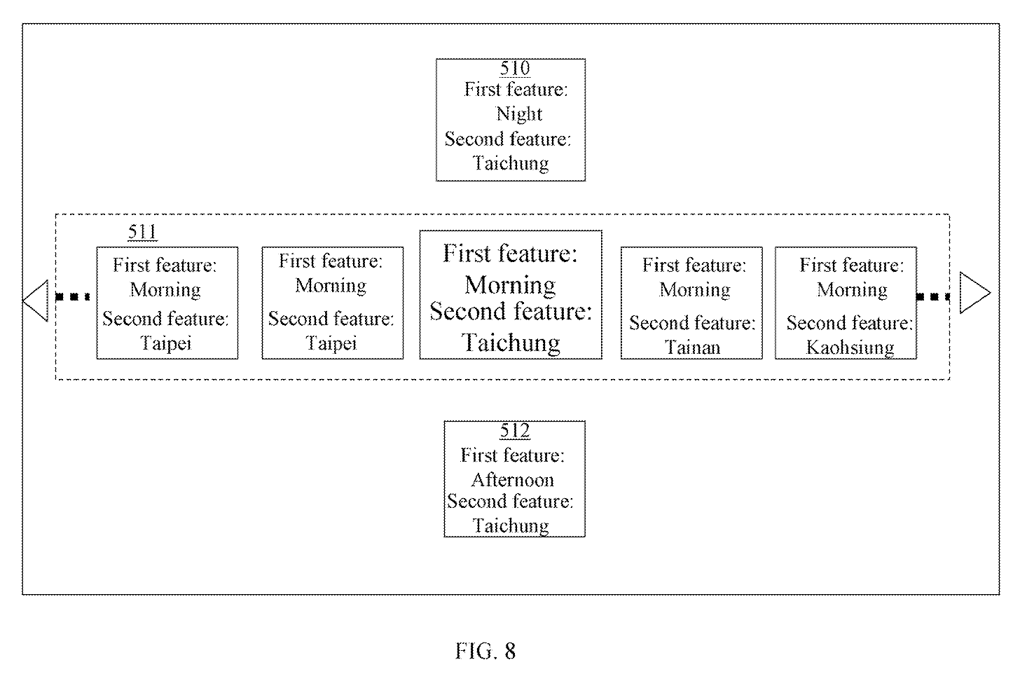

FIG. 8 is a block diagram of one embodiment of a second displaying mode of the image files classified and ranked by using the first display program 231. According to FIG. 8, the processor 220 classifies the image files into three categorized groups including a “Morning” categorized group 510, an “Afternoon” categorized group 511, and a “Night” categorized group 512 according to the first feature of each image file, namely a time parameter of each image file. The processor 220 also ranks the image files in each categorized group 510-512 according to the second feature of each image file, namely a geographic parameter of each image file including Taipei, Taichung, Tainan, or Kaohsiung. The processor 220 only displays the image files which are in the same categorized group with a currently selected image file. As seen from FIG. 8, the image file having the first feature “Morning” and the second feature “Taichung” is currently selected by a user using the control interface 240, such as the mouse, the keyboard, or the touch-panel. Thus, processor 220 displays the image files in the “Morning” categorized group 511 via the display screen 210. The processor 220 only displays representative images of the “Afternoon” categorized group 512 and the “Night” categorized group 510. In other embodiments, the processor 220 may display the “Afternoon” categorized group 512 and the “Night” categorized group 510 completely transparently or translucently via the display screen 210.

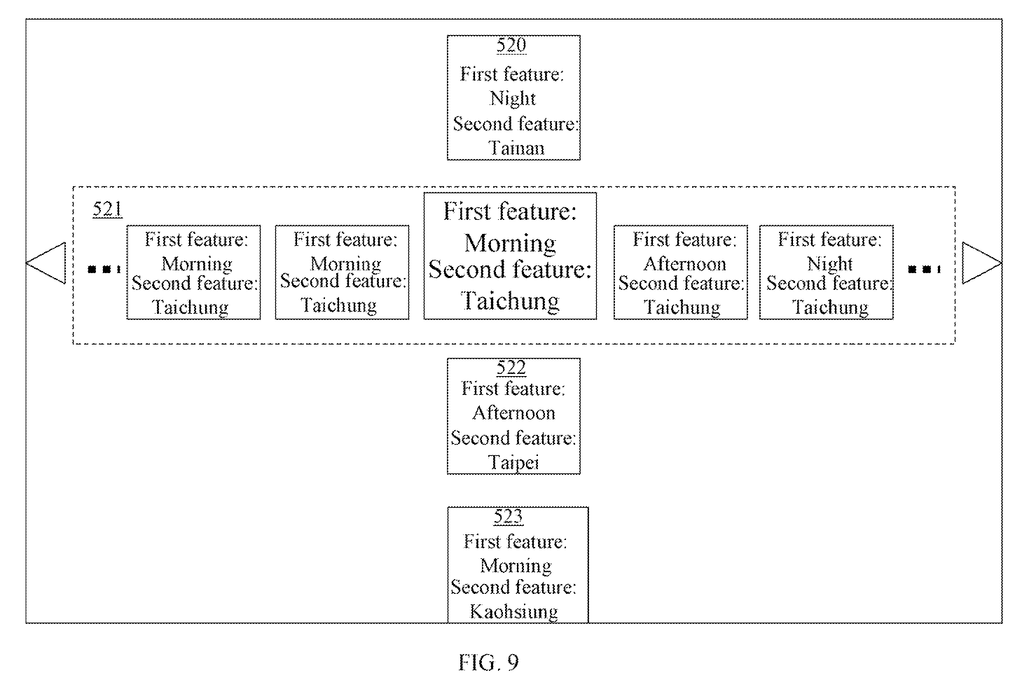

FIG. 9 is a block diagram of one embodiment of the second displaying mode of the image files processed by the second display program 232. According to FIG. 9, the processor 220 classifies the image files into four categorized groups including a “Tainan” categorized group 520, a “Taichung” categorized group 521, a “Taipei” categorized group 522, and a “Kaohsiung” categorized group 523 according to the second feature of each image file, namely a geographic parameter of each image file. The processor 220 also ranks the image files in each categorized group 520-523 according to the first feature of each image file, namely a time parameter of each image file including Morning, Afternoon, or Night. In one embodiment, the processor 220 only displays the image files which are in the same categorized group with a currently selected image file. As seen from FIG. 9, the image file having the first feature “Morning” and the second feature “Taichung” is currently selected by a user using the control interface 240, such as the mouse, the keyboard, or the touch-panel. Thus, processor 220 displays the image files in the “Taichung” categorized group 521 via the display screen 210. The processor 220 only displays representative images of the “Tainan” categorized group 520, “Taipei” categorized group 522, and the “Kaohsiung” categorized group 523. In other embodiments, the processor 220 may display the “Tainan” categorized group 520, “Taipei” categorized group 522, and the “Kaohsiung” categorized group 523 completely transparently or translucently via the display screen 210.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for displaying multimedia files via an electronic device, the method being performed by execution of computer readable program code by at least one processor of the electronic device, the method the method comprising:
classifying the multimedia files to generate one or more categorized groups according to a first feature of each multimedia file using the at least one processor;
ranking the multimedia files in each categorized group according to a second feature of each multimedia file using the at least one processor; and
displaying the multimedia files which have been classified according to the first feature of each multimedia file and ranked according to the second feature of each multimedia file via the electronic device using the at least one processor.

2. The method as described in claim 1, wherein the multimedia files are text files, image files, audio files, or video files.

3. The method as described in claim 1, wherein the first feature comprises a time parameter.

4. The method as described in claim 3, wherein the time parameter is a year, a quarter, a month, or a day,

5. The method as described in claim 1, further comprising:
classifying the multimedia files to generate one or more categorized groups according to the second feature of each multimedia file using the at least one processor;
ranking the multimedia files in each categorized group according to the first feature of each multimedia file using the at least one processor; and
displaying the multimedia files which have been classified according to the second feature of each multimedia file and ranked according to the first feature of each multimedia file via the electronic device using the at least one processor.

6. The method as described in claim 5, wherein the second feature comprises a geographic parameter.

7. The method as described in claim 6, wherein the geographic parameter is a longitude and latitude, or a locale.

8. An electronic device for displaying multimedia files, the electronic device comprising:
a storage system that stores the multimedia files, a first display program, and a second display program, wherein the first display program is operable to classify the multimedia files to one or more categorized groups according to a first feature of each multimedia file and rank the multimedia files in each categorized group according to a second feature of each multimedia file, and the second display program is operable to classify the multimedia files to one or more categorized groups according to the second feature of each multimedia file, and rank the multimedia files in each categorized group according to the first feature of each multimedia file;
a display screen operable to display the multimedia files;
a processor connected to the storage system for executing the first display program and the second display program to classify and rank the multimedia files; and
a control interface used to browse each multimedia file.

9. The electronic device as described in claim 8, wherein the multimedia files are text files, image files, audio files, or video files

10. The electronic device as described in claim 8, wherein the first feature comprises a time parameter, and the second feature comprises a geographic parameter.

11. The electronic device as described in claim 10, wherein the time parameter is a year, a quarter, a month, or a day.

12. The electronic device as described in claim 10, wherein the geographic parameter is a longitude and latitude, or a locale.

13. The electronic device as described in claim 8, further comprising:
a camera module to obtain the multimedia files and obtain the time parameter of each multimedia file; and
a GPS module to obtain the geographic parameter of each multimedia file.

14. A storage medium having stored thereon instructions that, when executed by a processor, causing the processor to perform a method for displaying multimedia files via an electronic device, the method comprising:
classifying the multimedia files to generate one or more categorized groups according to a first feature of each multimedia file;
ranking the multimedia files in each categorized group according to a second feature of each multimedia file; and
displaying the multimedia files which have been classified according to the first feature of each multimedia file and ranked according to the second feature of each multimedia file on the electronic device.

15. The storage medium as described in claim 14, wherein the multimedia files comprises text files, image files, audio files, or video files.

16. The storage medium as described in claim 14, wherein the first feature comprises a time parameter.

17. The storage medium as described in claim 16, wherein the time parameter is a year, a quarter, a month, or a day.

18. The storage medium as described in claim 14, wherein the method further comprises:
classifying the multimedia files to generate one or more categorized groups according to the second feature of each multimedia file;
ranking the multimedia files in each categorized group according to the first feature of each multimedia file; and
displaying the multimedia files which have been classified according to the second feature of each multimedia file and ranked according to the first feature of each multimedia file via the electronic device.

19. The storage medium as described in claim 18, wherein the second feature comprises a geographic parameter.

20. The storage medium as described in claim 19, wherein the geographic parameter is a longitude and latitude, or a locale.
